(19) United States
(12) Patent Application Publication
(10) Pub. No.: US 2021/0278687 A1
(43) Pub. Date: Sep. 9, 2021

(54) STABILIZING DEVICE, IMAGING DEVICE, PHOTOGRAPHIC SYSTEM, STABILIZING METHOD, PHOTOGRAPHIC METHOD, AND RECORDING MEDIUM STORING A PROGRAM

(71) Applicant: OLYMPUS CORPORATION, Tokyo (JP)

(72) Inventor: Hitoshi TSUCHIYA, Tokyo (JP)

(73) Assignee: OLYMPUS CORPORATION, Tokyo (JP)

(21) Appl. No.: 17/121,064

(22) Filed: Dec. 14, 2020

(30) Foreign Application Priority Data
Mar. 6, 2020 (JP) 2020-038311

(51) Int. Cl. G02B 27/64; G02B 23/12

(52) U.S. Cl. CPC G02B 27/644; H04N 5/2251; G02B 23/12

(57) ABSTRACT

A stabilizing device is provided with a correction mechanism that moves a target object, a control circuit that controls the correction mechanism, and an angular velocity sensor that detects a rotational angular velocity associated with an attitude change of the stabilizing device. When a specified mode is set, the control circuit controls the correction mechanism on a basis of a control angular velocity computed internally by the stabilizing device or a control angular velocity acquired from a source external to the stabilizing device, and at least rotates the target object.

### CROSS-REFERENCE TO RELATED APPLICATIONS

This application is based upon and claims the benefit of priority of the prior Japanese Patent Application No. 2020-038311, filed on Mar. 6, 2020, the entire contents of which are incorporated herein by reference.

### FIELD

Embodiments herein relate to a stabilizing device, an imaging device, a photographic system, a stabilizing method, a photographic method, and a recording medium storing a program.

### BACKGROUND

When photographing an astronomical object, because the astronomical object moves according to diurnal motion, the image (photographic image) flows according to the exposure time.

In the case of photographing a dark astronomical object, increasing the sensitivity of the image sensor to capture an image causes increased degradation of image quality due to noise. Accordingly, there are methods of tracking the motion of an astronomical object and moving the photographic field of view (photographic field of view movement methods) such that the image does not flow even if the exposure time is lengthened, while also securing adequate light intensity (exposure) without increasing the sensitivity.

One such photographic field of view movement method involves installing a camera on a mount that tracks the motion of an astronomical object. There are two types of mounts, namely equatorial mounts and altazimuth mounts.

With an equatorial mount, a rotational axis is set parallel to Earth's axis of rotation, and by rotating the mount to cancel out Earth's rotation during exposure, diurnal motion can be eliminated. However, equatorial mounts are heavy with little portability, labor-intensive to set up, and costly.

On the other hand, an altazimuth mount tracks an astronomical object on the two axes of azimuth and elevation. However, because the attitude of the camera is kept fixed while tracking, the photographic field of view rotates. Consequently, the image flows increasingly near the periphery of the photographic field of view, and therefore altazimuth mounts are unsuited to photographing a static image of an astronomical object.

Another photographic field of view movement method involves tracking the motion of an astronomical object by using a handheld camera shake correction mechanism of a camera. For example, as disclosed in Patent Literature 1 (Japanese Patent No. 5590121), latitude information about the photographing point, photographing azimuth information, photographing elevation information, information about the attitude of the photographic device, and information about the focal length of the photographic optical system is input, and all of the input information is used to compute a relative amount of movement for the photographic device to keep an astronomical image fixed with respect to a predetermined imaging region of an image sensor. Additionally, by moving at least one of the predetermined imaging region and the astronomical image on the basis of the computed relative amount of movement, photography that tracks the motion of an astronomical object is achieved.

### SUMMARY

One aspect of the embodiments is a stabilizing device including: a correction mechanism that moves a target object; a control circuit that controls the correction mechanism; and an angular velocity sensor that detects a rotational angular velocity associated with an attitude change of the stabilizing device. When a first mode is set, the control circuit controls the correction mechanism on a basis of the rotational angular velocity detected by the angular velocity sensor to rotate the target object and also move the target object in a horizontal direction and a vertical direction of the stabilizing device, and when a second mode is set, the control circuit controls the correction mechanism on a basis of a control angular velocity computed internally by the stabilizing device or a control angular velocity acquired from a source external to the stabilizing device, and at least rotates the target object.

Another aspect of the embodiments is an imaging device including: an optical system; an image sensor that converts a subject image formed by the optical system into an electrical signal; a correction mechanism that moves the image sensor; a control circuit that controls the correction mechanism; and an angular velocity sensor that detects a rotational angular velocity associated with an attitude change of the imaging device. When a first mode is set, the control circuit controls the correction mechanism on a basis of the rotational angular velocity detected by the angular velocity sensor to rotate the image sensor about an optical axis of the optical system and also move the image sensor in a horizontal direction and a vertical direction of the imaging device, and when a second mode is set, the control circuit controls the correction mechanism on a basis of a control angular velocity computed internally by the imaging device or a control angular velocity acquired from a source external to the imaging device, and at least rotates the image sensor about the optical axis of the optical system.

Another aspect of the embodiments is a photographic system including: an imaging device; and a stage device to which the imaging device is connected. The imaging device includes: an optical system; an image sensor that converts a subject image formed by the optical system into an electrical signal; a correction mechanism that moves the image sensor; a control circuit that controls the correction mechanism; and an angular velocity sensor that detects a rotational angular velocity associated with an attitude change of the imaging device. When a first mode is set, the control circuit controls the correction mechanism on a basis of the rotational angular velocity detected by the angular velocity sensor to rotate the image sensor about an optical axis of the optical system and also move the image sensor in a horizontal direction and a vertical direction of the imaging device, and when a second mode is set, the control circuit controls the correction mechanism on a basis of a control angular velocity computed internally by the imaging device or a control angular velocity acquired from a source external to the imaging device, and at least rotates the image sensor about the optical axis of the optical system. The stage device includes: a first rotating shaft that changes an azimuth of a photographing direction of the imaging device; a second rotating shaft that changes an elevation of the photographing direction of the imaging device; and a driving device that rotates the first rotating shaft and the second rotating shaft. The driving device rotates the first rotating shaft and the second rotating shaft such that the photographing direction of the imaging device tracks a target astronomical object.

Another aspect of the embodiments is a stabilizing method by a stabilizing device provided with a correction mechanism that moves a target object and an angular velocity sensor that detects a rotational angular velocity associated with an attitude change, including: when a first mode is set, controlling the correction mechanism on a basis of the rotational angular velocity detected by the angular velocity sensor to rotate the target object and also move the target object in a horizontal direction and a vertical direction of the stabilizing device, and when a second mode is set, controlling the correction mechanism on a basis of a control angular velocity computed internally by the stabilizing device or a control angular velocity acquired from a source external to the stabilizing device, and at least rotating the target object.

Another aspect of the embodiments is a photographic method of an imaging device provided with an optical system, an image sensor that converts a subject image formed by the optical system into an electrical signal, a correction mechanism that moves the image sensor, and an angular velocity sensor that detects a rotational angular velocity associated with an attitude change, including: when a first mode is set, controlling the correction mechanism on a basis of the rotational angular velocity detected by the angular velocity sensor to rotate the image sensor about an optical axis of the optical system and also move the image sensor in a horizontal direction and a vertical direction of the imaging device, and when a second mode is set, controlling the correction mechanism on a basis of a control angular velocity computed internally by the imaging device or a control angular velocity acquired from a source external to the imaging device, and at least rotating the image sensor about the optical axis of the optical system.

Another aspect of the embodiments is a non-transitory recording medium storing a program causing a processor to execute a photographic control process, wherein the photographic control process includes an imaging device control process. The imaging device control process causes an imaging device provided with an optical system, an image sensor that converts a subject image formed by the optical system into an electrical signal, a correction mechanism that moves the image sensor, and an angular velocity sensor that detects a rotational angular velocity associated with an attitude change to execute a process that, when a first mode is set, controls the correction mechanism on a basis of the rotational angular velocity detected by the angular velocity sensor to rotate the image sensor about an optical axis of the optical system and also move the image sensor in a horizontal direction and a vertical direction of the imaging device, and when a second mode is set, controls the correction mechanism on a basis of a control angular velocity computed internally by the imaging device or a control angular velocity acquired from a source external to the imaging device, and at least rotates the image sensor about the optical axis of the optical system.

### BRIEF DESCRIPTION OF DRAWINGS

FIG. 1 is a diagram illustrating an example of a configuration of a photographic system according to a first embodiment.

FIG. 2 is a diagram illustrating an example of a configuration of a camera according to the first embodiment.

FIG. 3 is a diagram illustrating an example of a driving mechanism of a driving unit.

FIG. 4 is a diagram illustrating an example of a configuration of a blurring correction microcomputer.

FIG. 5 is a diagram illustrating an example of a configuration of a system controller.

FIG. 6 is a diagram illustrating an example of a configuration of a control unit provided in an altazimuth mount.

FIG. 7 is a diagram illustrating an example of a configuration of a hand controller.

FIG. 8 is a flowchart illustrating an example of a flow of a photographic process performed by the system controller.

FIG. 9 is a flowchart illustrating an example of a flow of an altazimuth mount control process performed by the hand controller.

FIG. 10 is a timing chart illustrating an example of operations by an image sensor, the driving unit, and the altazimuth mount arranged in a time series in the photographic system according to the first embodiment.

FIG. 11 is a diagram illustrating an example of a configuration of a photographic system according to a second embodiment.

FIG. 12 is a diagram illustrating an example of a configuration of a camera according to the second embodiment.

FIG. 13 is a diagram illustrating an example of a configuration of an operating terminal.

FIG. 14 is a flowchart illustrating an example of a flow of a camera control process performed by the operating terminal.

FIG. 15 is a timing chart illustrating an example of operations by an image sensor, the driving unit, and the altazimuth mount arranged in a time series in the photographic system according to the second embodiment.

FIG. 16 is a flowchart illustrating an example of a flow of an altazimuth mount control process periodically performed by the operating terminal.

FIG. 17 is a timing chart illustrating an example of operations by an image sensor, a driving unit, and an altazimuth mount arranged in a time series in a photographic system according to a third embodiment.

### DESCRIPTION OF EMBODIMENTS

Hereinafter, embodiments will be described with reference to the drawings.

The photographic field of view movement method disclosed in Patent Literature 1 (Japanese Patent No. 5590121) has the advantages of being easy to set up and achievable at relatively low cost. However, the available range for moving an image with a handheld camera shake correction mechanism is limited, and an astronomical object can only be tracked within that limited range. Accordingly, in some cases an image of an astronomical object is generated by tracking and photographing the astronomical object multiple times in succession, and then aligning and compositing the photographic images together. However, in these cases, a technical challenge arises in that, because the position of the astronomical object in the photographic image is different for each photographic image, as the number of photographic images to align and composite increases, the angle of view of the astronomical image to be generated is narrowed (that is, the overlapping portion of the photographic images becomes smaller).

The embodiments described hereinafter focus on the above technical challenge, and an object thereof is to provide a technology that, by linking an altazimuth mount and a handheld camera shake correction mechanism, makes it possible to achieve photography on a par with an equatorial mount with a configuration that is easy to set up and also relatively low-cost.

### First Embodiment

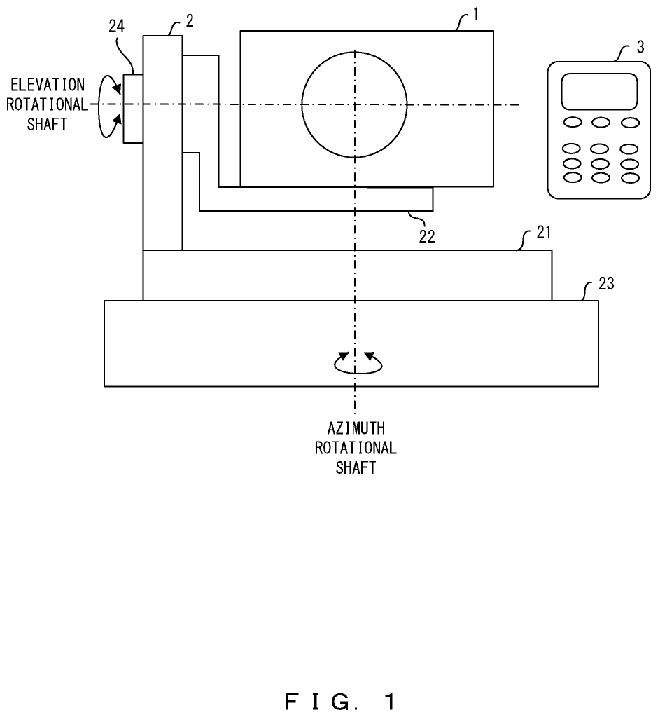

FIG. 1 is a diagram illustrating an example of a configuration of a photographic system according to a first embodiment.

The photographic system exemplified in FIG. 1 is provided with a camera 1 (one example of an imaging device or a stabilizing device), an altazimuth mount 2 on which the camera 1 is installed (one example of a stage device), and a hand controller 3 that controls operations by the altazimuth mount 2.

The camera 1 is a camera provided with a handheld camera shake correction mechanism, and is a camera with a fixed or interchangeable lens.

The altazimuth mount 2 is provided with a rotating stage 21, a securing bracket 22, a pedestal 23, and an elevation shaft 24 (one example of a second rotational shaft). The securing bracket 22 is an L-shaped bracket for joining the altazimuth mount 2 and the camera 1, and is secured by being screwed into a tripod hole of the camera 1. The pedestal 23 is for keeping the altazimuth mount 2 horizontal, and may be configured like a tripod, for example. The rotating stage 21 is a mechanism that rotates with respect to the pedestal 23 by rotation about an internal azimuth rotational shaft (one example of a first rotating shaft), and changes the azimuth of the photographing direction (photographic optical axis) of the camera 1 through such rotation. The azimuth rotational shaft is one example of the first rotating shaft. The elevation shaft 24 changes the elevation angle of the photographing direction of the camera 1 due to the securing bracket 22 linked to the elevation shaft 24 rotating about the elevation shaft 24. The elevation shaft 24 is one example of the second rotational shaft.

The hand controller 3 controls the altazimuth mount 2. For example, the hand controller 3 controls the rotating stage 21 and the elevation shaft 24 of the altazimuth mount 2. With this arrangement, the hand controller 3 is capable of controlling the azimuth and the elevation of the photographing direction of the camera 1, and is capable of pointing the photographing direction of the camera 1 toward a target astronomical object. Also, the azimuth and elevation of the photographing direction of the camera 1 can also be controlled to change in accordance with diurnal motion, such that the target astronomical object is positioned in the center of the angle of view of the camera 1.

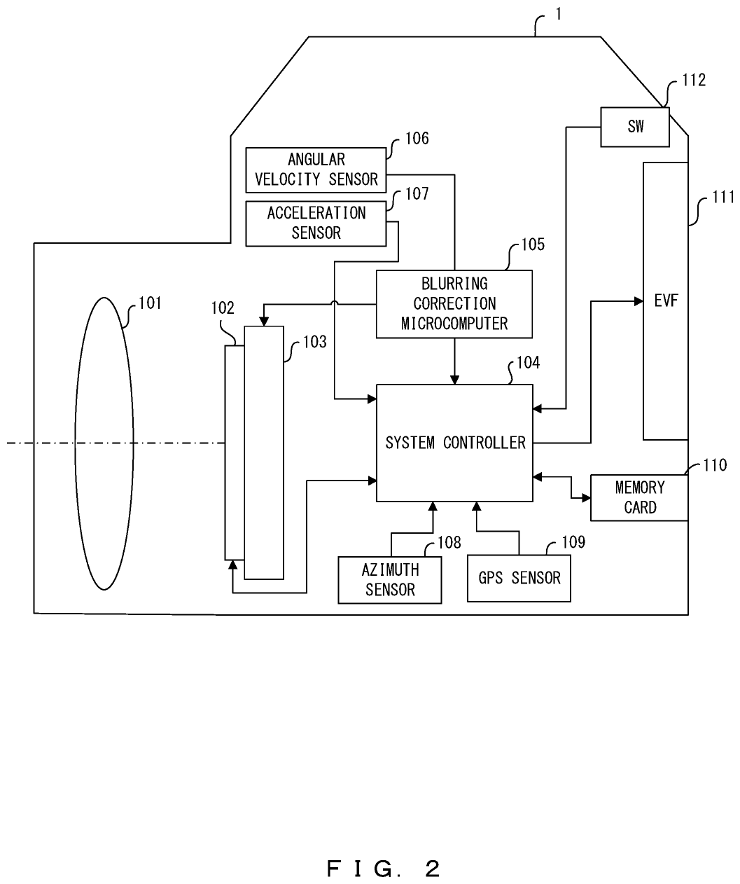

FIG. 2 is a diagram illustrating an example of a configuration of the camera 1 according to the first embodiment.

The camera 1 exemplified in FIG. 2 is provided with an optical system 101, an image sensor 102 (one example of a target object), a driving unit 103 (one example of a correction mechanism), a system controller 104 (one example of an image processor), a blurring correction microcomputer 105 (one example of a control circuit), an angular velocity sensor 106, an acceleration sensor 107, an azimuth sensor 108 (one example of an azimuth information acquisition circuit), a Global Positioning System (GPS) sensor 109 (one example of a current position information acquisition circuit), a memory card 110, an electronic viewfinder (EVF) 111, and a switch (SW) 112.

The optical system 101 focuses luminous flux from a subject onto the imaging surface of the image sensor 102. The optical system 101 includes a plurality of lenses including a focus lens, for example.

The image sensor 102 converts a subject image formed on the imaging surface into an electrical signal. The image sensor 102 is an image sensor such as a charge-coupled device (CCD) sensor or a complementary metal-oxide-semiconductor (CMOS) sensor, for example.

The driving unit 103 is a mechanism that causes the image sensor 102 to move freely in the upward, downward, leftward, and rightward directions (the vertical and horizontal directions of the camera) in a plane that contains the imaging surface of the image sensor 102 and also causes the image sensor 102 to rotate freely about the optical axis of the optical system 101, on the basis of a driving instruction (driving amount instruction) from the blurring correction microcomputer 105.

The system controller 104 controls overall operations by the camera 1. For example, the system controller 104 controls the exposure of the image sensor 102. As another example, the system controller 104 reads out an electrical signal converted by the image sensor 102 as video image data, and performs live-view image processing causing the EVF 111 to display the read-out video image data as a live-view video image, or performs recording image processing (image processing corresponding to a recording format) causing the read-out video image data to be recorded to the memory card 110. As another example, the system controller 104 computes parameters relevant to the control of each unit related to photography and astronomical object tracking. As another example, the system controller 104 extracts a gravitational component from accelerations in multiple directions detected by the acceleration sensor 107 and computes an inclination with respect to the gravitational direction to detect the attitude of the camera 1 or the like.

The angular velocity sensor 106 detects the angular velocity of the camera 1 in a yaw direction, a pitch direction, and a roll direction. Here, the angular velocity of the camera 1 in the yaw direction, the pitch direction, and the roll direction is also the angular velocity of the camera 1 about a Y axis, an X axis, and a Z axis. The angular velocity of the camera 1 about the Y axis, the X axis, and the Z axis is the angular velocity of the camera 1 about an axis in the up-and-down direction, an axis in the left-and-right direction, and the optical axis of the optical system 101. A plane containing the Y axis and the X axis of the camera 1 is also the plane containing the imaging surface of the image sensor 102.

The acceleration sensor 107 detects the acceleration of the camera 1 in multiple directions.

The blurring correction microcomputer 105 reads out the angular velocity detected by the angular velocity sensor 106, computes an image movement amount for the imaging surface of the image sensor 102 on the basis of the angular velocity, and controls the driving unit 103 to move the image sensor 102 in a direction that cancels out the image movement amount. In addition, as described in detail later, the blurring correction microcomputer 105 controls the driving unit 103 on the basis of an angular velocity of earth (rotation) in at least the roll direction of the camera 1.

The azimuth sensor 108 detects geomagnetism, and detects the azimuth of the photographing direction of the camera 1 on the basis of the detected geomagnetism.

The GPS sensor 109 detects at least the latitude of the current position of the camera 1.

The memory card 110 is non-volatile memory that is removable from the camera 1, such as an SD memory card for example.

The EVF 111 is a display device such as a liquid crystal display (LCD) panel or an organic electroluminescence (EL) panel.

The SW 112 is a switch that detects and notifies the system controller 104 of a user operation, and is used when the user gives an instruction to start photographing, an instruction selecting an operating mode, or the like.

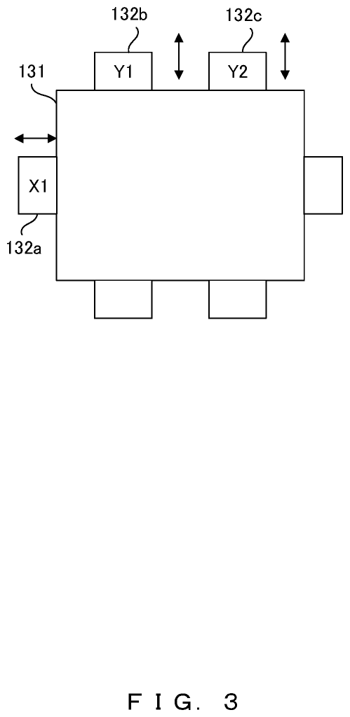

FIG. 3 is a diagram illustrating an example of a driving mechanism of the driving unit 103.

The driving mechanism of the driving unit 103 exemplified in FIG. 3 is provided with a driving stage 131 to which the image sensor 102 is affixed, and three actuators 132 (an X1 actuator 132a, a Y1 actuator 132b, and a Y2 actuator 132c) for controlling the position of the driving stage 131. Each actuator 132 is a linear actuator such as a voice coil motor (VCM), for example.

With such a driving mechanism, the movement of the driving stage 131 in the horizontal direction (X axis direction, the left-and-right direction in FIG. 3) is controlled by the X1 actuator 132a, while the movement and rotation of the driving stage 131 in the vertical direction (Y axis direction, and up-and-down direction in FIG. 3) are controlled by the Y1 actuator 132b and the Y2 actuator 132c. Here, the movement of the driving stage 131 in the vertical direction is performed by instructing the Y1 actuator 132b and the Y2 actuator 132c to move the same amount in the same direction. The rotation of the driving stage 131 is performed by instructing the Y1 actuator 132b and the Y2 actuator 132c to move the same amount in opposite directions.

Note that the driving mechanism of the driving unit 103 is not limited to the one exemplified in FIG. 3, and for example, movement control of the driving stage 131 in the horizontal direction may be performed by two actuators, and rotational control of the driving stage 131 may also be performed by the two actuators. In this case, movement control of the driving stage 131 in the vertical direction may be performed by a single actuator. Additionally, the rotational control of the driving stage 131 may also be performed by an actuator other than a VCM, such as a stepping motor for example.

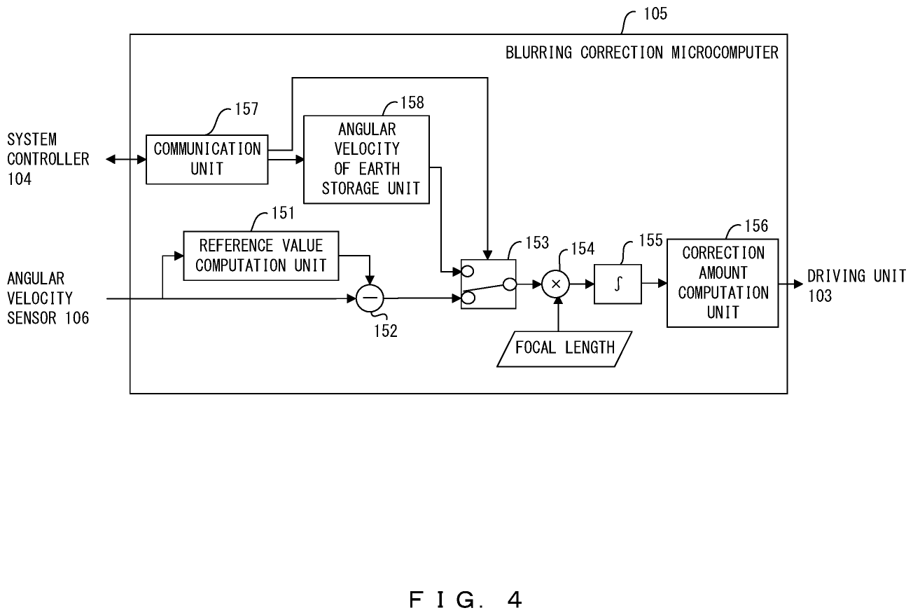

FIG. 4 is a diagram illustrating an example of the configuration of the blurring correction microcomputer 105.

The blurring correction microcomputer 105 has, as a configuration that performs processing on the basis of the angular velocity, a configuration that performs processing on the basis of the angular velocity in the yaw direction, a configuration that performs processing on the basis of the angular velocity in the pitch direction, and a configuration that performs processing on the basis of the angular velocity in the roll direction, but these three configurations are the same or substantially the same. Specifically, the configuration that performs processing on the basis of the angular velocity in the yaw direction and the configuration that performs processing on the basis of the angular velocity in the pitch direction are the same. Also, the configuration that performs processing on the basis of the angular velocity in the roll direction is a configuration from which a multiplier 154 described later has been removed compared to the configuration that performs processing on the basis of the angular velocity in the yaw direction (or the pitch direction). Accordingly, in the following, only the configuration that performs processing on the basis of the angular velocity in the yaw direction (or the pitch direction) will be illustrated in FIG. 4 and described as the configuration that performs processing on the basis of the angular velocity.

The blurring correction microcomputer 105 exemplified in FIG. 4 is provided with a reference value computation unit 151, a subtractor 152, a mode toggle switch 153, a multiplier 154, an integrator 155, a correction amount computation unit 156, a communication unit 157, and an angular velocity of earth storage unit 158. Here, the configuration that performs processing on the basis of the angular velocity in the yaw direction (or the pitch direction) is each of the units except the communication unit 157 (that is, the reference value computation unit 151, the subtractor 152, the mode toggle switch 153, the multiplier 154, the integrator 155, the correction amount computation unit 156, and the angular velocity of earth storage unit 158).

The reference value computation unit 151 computes and stores a reference value on the basis of the angular velocity detected by the angular velocity sensor 106 when the camera 1 is in a still state. For example, the reference value computation unit 151 computes and stores an average value (time average value) of the angular velocity detected for the duration of a predetermined length of time while the camera 1 remains in a still state as the reference value. The method of computing the reference value is not limited to the above, and may be any computation method insofar as a reference value with minimal error is computed.

The subtractor 152 subtracts the reference value stored in the reference value computation unit 151 from the angular velocity detected by the angular velocity sensor 106. The sign of the value of the subtracted result is treated as expressing the rotational direction of the angular velocity.

The communication unit 157 is a communication interface that communicates with the system controller 104, and acquires parameters (such as the angular velocity of earth and the focal length of the optical system 101) or receives instructions (such as a mode instruction, an instruction to start correction, and an instruction to end correction) from the system controller 104, for example.

The angular velocity of earth storage unit 158 stores the angular velocity of earth (one example of a control angular velocity) acquired from the system controller 104 through the communication unit 157. The angular velocity of earth is the angular velocity occurring in the camera 1 due to Earth's rotation (here, the angular velocity of earth in the yaw direction (or the pitch direction) of the camera 1).

The mode toggle switch 153 toggles the angular velocity to output between the angular velocity subtracted by the subtractor 152 and the angular velocity of earth stored in the angular velocity of earth storage unit 158, according to a mode instruction from the system controller 104. For example, in the case where the mode instruction indicates a normal mode (one example of a first mode), the angular velocity to output is toggled to the angular velocity subtracted by the subtractor 152. Also, in the case where the mode instruction indicates an astrophotography mode (one example of a second mode), the angular velocity to output is toggled to the angular velocity of earth stored in the angular velocity of earth storage unit 158. FIG. 4 illustrates the toggle state for the case where the mode instruction indicates the normal mode.

The multiplier 154 multiplies the focal length of the optical system 101 by the angular velocity output from the mode toggle switch 153. The focal length of the optical system 101 is reported by the system controller 104 through the communication unit 157, for example.

The integrator 155 time-integrates the multiplication results from the multiplier 154 to compute the image movement amount (the amount of image movement on the imaging surface of the image sensor 102).

The correction amount computation unit 156 computes a driving amount (which also acts as a correction amount) by the driving unit 103 for moving the image sensor 102 in the direction that cancels out the image movement amount computed by the integrator 155, and outputs to the driving unit 103.

Note that because the multiplier 154 is excluded in the configuration that performs processing on the basis of the angular velocity in the roll direction not illustrated, the integrator 155 time-integrates the angular velocity output from the mode toggle switch 153 to compute the image movement amount. Additionally, in the correction amount computation unit 156, the driving amount by the driving unit 103 for rotating the image sensor 102 in the direction that cancels out the image movement amount is computed and output to the driving unit 103.

According to the blurring correction microcomputer 105 having such a configuration, in the case where the mode instruction from the system controller 104 indicates the normal mode, image blurring is corrected on the basis of the angular velocity detected by the angular velocity sensor 106, and therefore handheld camera shake is corrected. On the other hand, in the case where the mode instruction from the system controller 104 indicates the astrophotography mode, image blurring is corrected on the basis of the angular velocity of earth, and therefore the image sensor 102 operates so as to track the motion of the astronomical object, and the image blurring that occurs due to diurnal motion is corrected. Here, in the case of correcting only the rotation of the image, it is sufficient for the system controller 104 to cause the corresponding angular velocity of earth storage unit 158 to store 0 as the angular velocity of earth in the yaw direction and the pitch direction.

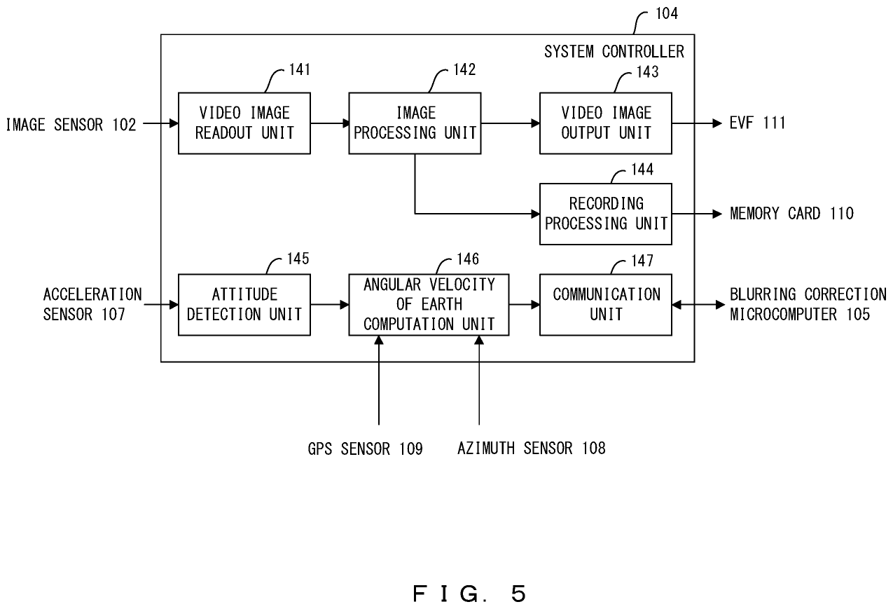

FIG. 5 is a diagram illustrating an example of a configuration of the system controller 104.

The system controller 104 exemplified in FIG. 5 is provided with a video image readout unit 141, an image processing unit 142, a video image output unit 143, a recording processing unit 144, an attitude detection unit 145 (one example of an attitude information acquisition circuit), an angular velocity of earth computation unit 146, and a communication unit 147.

The video image readout unit 141 outputs a horizontal synchronization signal and a vertical synchronization signal to the image sensor 102, and reads out the signal charge stored by the photoelectric conversion by the image sensor 102 as video image data (image data).

The image processing unit 142 performs a variety of image processing on the video image data read out by the video image readout unit 141. For example, the image processing unit 142 performs image processing for display (such as live-view image processing), image processing for recording (such as image processing corresponding to a recording format), and image processing for composite photography. In the image processing for composite photography, multiple frames of image data are aligned by rotating the images or the like, and then the images are combined. In addition, the image processing unit 142 combines the multiple frames of image data according to a cumulative additive method or an additive-averaging method, for example.

The video image output unit 143 outputs the video image data that has been subjected to image processing by the image processing unit 142 (such as image processing for display, for example) to the EVF 111, and the video image is displayed on the EVF 111.

The recording processing unit 144 records the video image data that has been subjected to image processing by the image processing unit 142 (such as image processing for recording, for example) to the memory card 110.

The attitude detection unit 145 detects a gravity vector from the accelerations in multiple directions detected by the acceleration sensor 107, and from the discrepancy between the gravity vector and the coordinates of the camera 1, detects the attitude of the camera 1 such as the elevation of the photographing direction of the camera 1.

The angular velocity of earth computation unit 146 computes the angular velocity of earth in the yaw direction, the pitch direction, and the roll direction of the camera 1 on the basis of the elevation detected by the attitude detection unit 145, the direction (azimuth) detected by the azimuth sensor 108, and the latitude detected by the GPS sensor 109. This computation may use the computation method disclosed in International Patent Publication No. PCT/JP2019/035004 previously submitted by the applicant, for example.

The communication unit 147 is a communication interface that communicates with the blurring correction microcomputer 105. For example, the communication unit 147 transmits the angular velocity of earth computed by the angular velocity of earth computation unit 146 to the blurring correction microcomputer 105. As another example, in the case where the astrophotography mode is selected (set) according to an operation of the SW 112 by the user, the communication unit 147 issues a mode instruction indicating the astrophotography mode to the blurring correction microcomputer 105. Also, in the case where the normal mode is selected (set) according to an operation of the SW 112 by the user, the communication unit 147 issues a mode instruction indicating the normal mode to the blurring correction microcomputer 105.

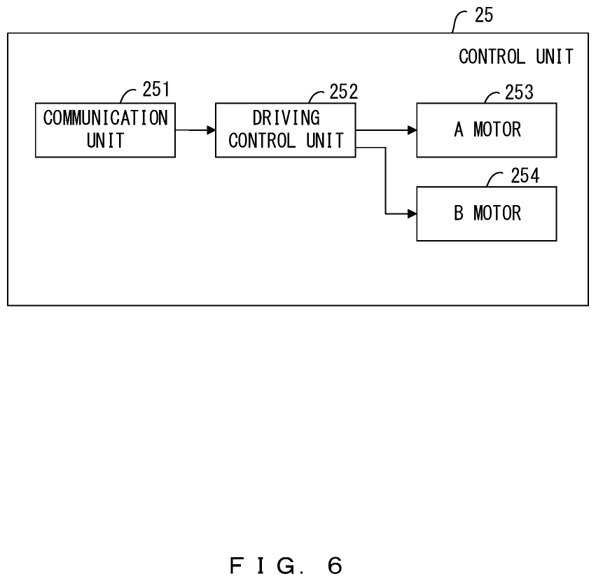

FIG. 6 is a diagram illustrating an example of a configuration of a control unit provided in the altazimuth mount 2.

A control unit 25 of the altazimuth mount 2 exemplified in FIG. 6 is provided with a communication unit 251, a driving control unit 252 (one example of a driving device), an A motor 253, and a B motor 254.

The communication unit 251 is a communication interface that communicates with the hand controller 3 in a wired or wireless way, and acquires the azimuth and the elevation from the hand controller 3, for example.

The driving control unit 252 controls the driving of the A motor 253 and the B motor 254 on the basis of the azimuth and the elevation acquired from the hand controller 3 through the communication unit 251. Specifically, the driving control unit 252 controls the driving of the A motor 253 on the basis of the acquired azimuth to rotate the rotating stage 21 (azimuth rotational shaft), and also controls the driving of the B motor 254 on the basis of the acquired elevation to rotate the elevation shaft 24.

The A motor 253 is an actuator that rotates the rotating stage 21, while the B motor 254 is an actuator that rotates the elevation shaft 24. The A motor 253 and the B motor 254 are stepping motors, for example.

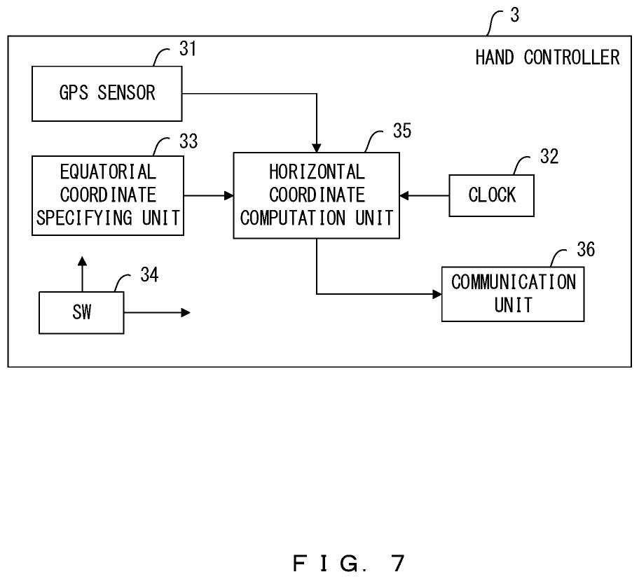

FIG. 7 is a diagram illustrating an example of the configuration of the hand controller 3.

The hand controller 3 exemplified in FIG. 7 is provided with a GPS sensor 31, a clock 32, an equatorial coordinate specifying unit 33, a SW 34, a horizontal coordinate computation unit 35, and a communication unit 36.

The GPS sensor 31 detects the latitude and longitude of the current position of the hand controller 3.

The clock 32 is a clock circuit that outputs the current date and time.

The equatorial coordinate specifying unit 33 outputs a right ascension and a declination specified by the user. For example, the equatorial coordinate specifying unit 33 displays a star chart on a display unit not illustrated that is provided in the hand controller 3, and outputs the right ascension and the declination of a point specified by the user on the star chart. Alternatively, for example, the equatorial coordinate specifying unit 33 acquires and outputs, from a database not illustrated, the right ascension and the declination of the astronomical object having a name specified by the user. The database may be internal or external to the hand controller 3. In the case of an external database, the right ascension and the declination may be acquired from the database through the communication unit 36. In this way, the equatorial coordinate specifying unit 33 may be any configuration that outputs a right ascension and a declination on the basis of a user specification.

The horizontal coordinate computation unit 35 computes the azimuth and the elevation corresponding to the right ascension and the declination output by the equatorial coordinate specifying unit 33, on the basis of the latitude and longitude of the current position detected by the GPS sensor 31 and the current date and time output by the clock 32. This computation is known and therefore will not be described in detail, but the computation may be performed as follows, for example. First, the Julian date is obtained from the current date and time, and the Greenwich Sidereal Time is computed. Next, the local sidereal time is computed on the basis of the longitude of the current position, and the hour angle is obtained. Thereafter, the azimuth and the elevation are obtained from hour angle, the right ascension and declination, and the latitude of the current position.

The SW 34 is a switch used when the user gives an instruction such as an instruction to start or end the driving of the altazimuth mount 2, or an instruction to set various settings with respect to the hand controller 3.

The communication unit 36 is a communication interface that communicates with the altazimuth mount 2 in a wired or wireless way, and transmits the azimuth and the elevation computed by the horizontal coordinate computation unit 35 to the altazimuth mount 2, for example.

In the configuration of the photographic system according to the first embodiment described so far, the configuration of a portion of the camera 1 (such as the system controller 104 and the blurring correction microcomputer 105), the configuration of a portion of the control unit 25 of the altazimuth mount 2 (such as the driving control unit 252), and the configuration of a portion of the hand controller 3 (such as the equatorial coordinate specifying unit 33 and the horizontal coordinate computation unit 35) may be achieved by using hardware including a processor such as a central processing unit (CPU) and memory, for example, in which the functions of the configuration are achieved by causing the processor to execute a program stored in the memory. Alternatively, for example, the above configuration may be achieved by using a dedicated circuit such as an application-specific integrated circuit (ASIC) or a field-programmable gate array (FPGA).

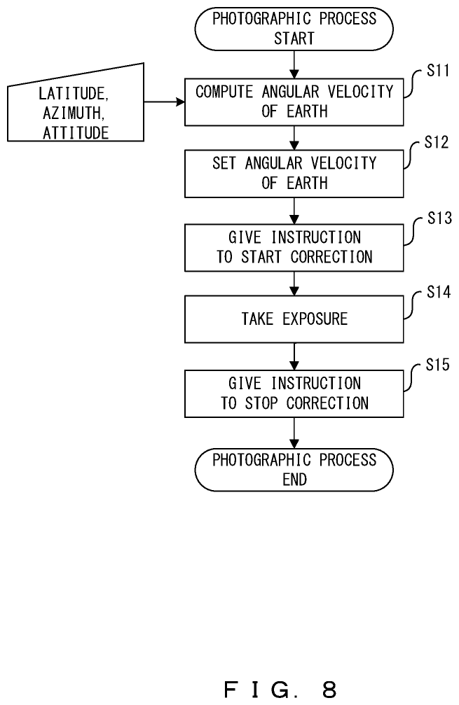

FIG. 8 is a flowchart illustrating an example of a flow of a photographic process performed by the system controller 104. The photographic process is started when the user selects the astrophotography mode in the camera 1 and gives an instruction to start photographing.

When the photographic process exemplified in FIG. 8 is stated, first, the system controller 104 computes the angular velocity of earth in the yaw direction, the pitch direction, and the roll direction of the camera 1 (S11). Specifically, the angular velocity of earth computation unit 146 computes the angular velocity of earth in the yaw direction, the pitch direction, and the roll direction of the camera 1 on the basis of the attitude (elevation) detected by the attitude detection unit 145, the azimuth detected by the azimuth sensor 108, and the latitude of the current position detected by the GPS sensor 109. For example, in the case where the attitude of the camera 1 is horizontal (that is, in the case where the X axis of the camera 1 is horizontal), the following formulas (1) to (3) can be used to compute the angular velocity of earth (ω_{pitch}, ω_{yaw}, and ωᵣₒₗₗ) in the pitch direction, the yaw direction, and the roll direction of the camera 1.

ω_{pitch}=ωᵣₒₜ×(cos θₗₐₜ×sin θ_{direction}) Formula (1)

ω_{yaw}=ωᵣₒₜ×(sin θₗₐₜ×cos θₑₗₑ−cos θₗₐₜ×cos θ_{direction}×sin θₑₗₑ) Formula (2)

ωᵣₒₗₗ=ωᵣₒₜ×(cos θₗₐₜ×cos θ_{direction}×cos θₑₗₑ+sin θₗₐₜ×sin θₑₗₑ) Formula (3)

Here, ωᵣₒₜ is the angular velocity of earth, θₗₐₜ is the latitude, θ_{direction} is the direction (azimuth), and θₑₗₑ is the altitude (elevation). Note that details regarding Formulas (1) to (3) are disclosed in International Patent Publication No. PCT/JP2019/035004 described above.

Next, the system controller 104 sets the angular velocity of earth of the camera 1 in the yaw direction, the pitch direction, and the roll direction computed in S11 in the blurring correction microcomputer 105 (S12). Specifically, the communication unit 147 transmits the angular velocity of earth of the camera 1 in the yaw direction, the pitch direction, and the roll direction computed by the angular velocity of earth computation unit 146 to the blurring correction microcomputer 105, and causes each angular velocity of earth to be stored in the corresponding angular velocity of earth storage unit 158.

At this point, because the camera 1 is presumed to be mounted on the altazimuth mount 2 to take images, in S12, it is assumed that 0 is set as the angular velocity of earth of the camera 1 in the yaw direction and the pitch direction, and the angular velocity of earth in the roll direction (ωᵣₒₗₗ) computed in S11 is set as the angular velocity of earth of the camera 1 in the roll direction.

Next, the system controller 104 instructs the blurring correction microcomputer 105 to start correction (start image blurring correction) (S13). With this arrangement, an operation of moving (in this case, rotating) the image sensor 102 so as to cancel out the image movement that occurs due to diurnal motion is started.

Next, the system controller 104 starts exposure (S14).

After that, when an instruction to end exposure is given by the user or after a predetermined exposure time (such as an exposure time specified by the user in advance) elapses, the system controller 104 instructs the blurring correction microcomputer 105 to end correction (end image blurring correction) (S15), and the photographic process exemplified in FIG. 8 ends.

According to such a photographic process, when taking a photograph while causing the photographic optical axis of the camera 1 to track the motion of an astronomical object using the altazimuth mount 2, rotation of the photographic field of view does not occur at least during exposure. Consequently, image blurring associated with the rotation of the photographic field of view does not occur at least during exposure.

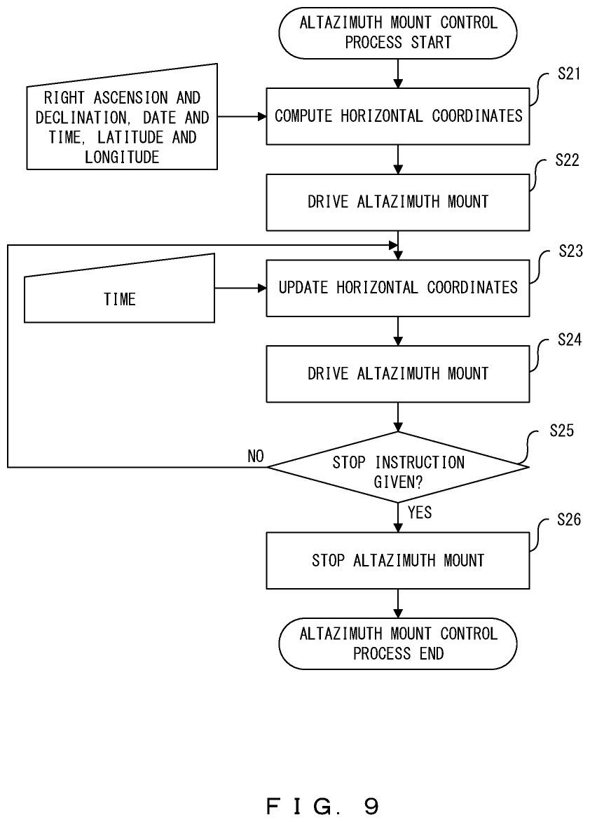

FIG. 9 is a flowchart illustrating an example of a flow of an altazimuth mount control process performed by the hand controller 3.

When the altazimuth mount control process exemplified in FIG. 9 starts, first, the hand controller 3 computes horizontal coordinates (azimuth and elevation) corresponding to the right ascension and declination based on a user specification (S21). Specifically, the horizontal coordinate computation unit 35 computes the azimuth and the elevation corresponding to the right ascension and the declination output by the equatorial coordinate specifying unit 33, on the basis of the latitude and longitude of the current position detected by the GPS sensor 31 and the current date and time output by the clock 32.

Next, the hand controller 3 drives the altazimuth mount 2 on the basis of the horizontal coordinates computed in S21 (S22). Specifically, the communication unit 36 transmits the azimuth and elevation computed by the horizontal coordinate computation unit 35 to the altazimuth mount 2, and the altazimuth mount 2 rotates the rotating stage 21 and the elevation shaft 24 on the basis of the azimuth and elevation. With this arrangement, the photographic optical axis of the camera 1 can be pointed toward the horizontal coordinates based on the user specification.

Note that the operations according to the processes in S21 and S22 are also referred to as the automatic adoption of an astronomical object, and when an astronomical object is specified, the photographic field of view of the camera 1 can be pointed toward the position where the astronomical object is currently visible, and the subject (specified astronomical object, target astronomical object) can be captured easily.

Next, the hand controller 3 updates the horizontal coordinates (S23). Specifically, the horizontal coordinates (azimuth and elevation) corresponding to the right ascension and declination based on the user specification in S21 are computed for the current date and time after some time has elapsed since the previous computation of the horizontal coordinates. The computation at this time is performed similarly to the computation in S21. However, because the information other than the current date and time, namely the latitude and longitude at the current position as well as the right ascension and declination based on the user specification, are the same as those used in the computation in S21, it is not necessary to newly acquire the same information in S23.

Next, the hand controller 3 drives the altazimuth mount 2 on the basis of the updated (computed) horizontal coordinates computed in S23 (S24). This driving is performed similarly to the driving in S22.

Next, the hand controller 3 determines whether or not the user has given a stop instruction (S25), and if the determination result is NO, the process returns to S23.

On the other hand, if the determination result in S25 is YES, the hand controller 3 stops the driving of the altazimuth mount 2 (S26), and the altazimuth mount control process exemplified in FIG. 9 ends.

Note that the operation according to the NO process from S23 to S25 is also referred to as an astronomical object tracking operation, and works to keep the target astronomical object at a specific position in the angle of view.

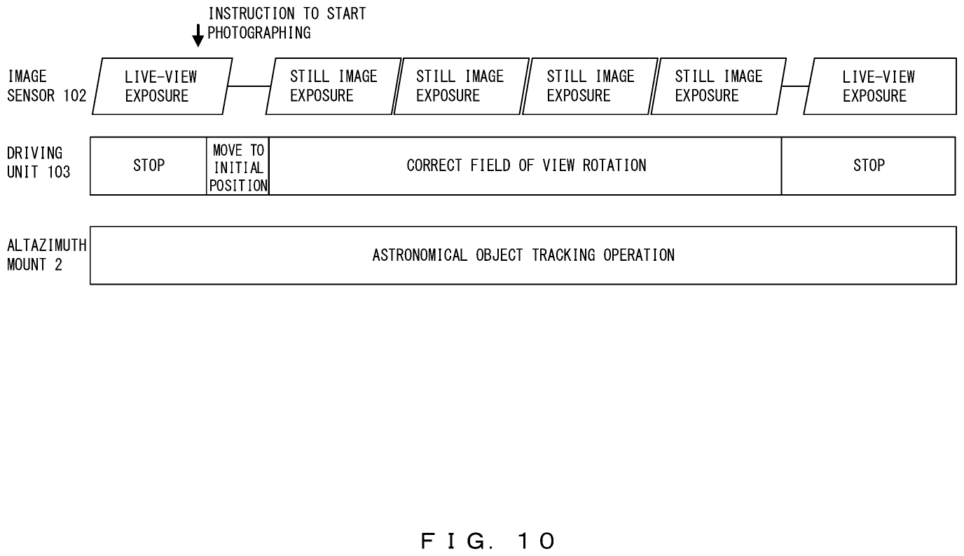

FIG. 10 is a timing chart illustrating an example of operations by the image sensor 102, the driving unit 103, and the altazimuth mount 2 arranged in a time series in the photographic system according to the first embodiment.

In the timing chart exemplified in FIG. 10, before the user gives an instruction to start photographing, the image sensor 102 performs a live-view exposure (an exposure operation for a live view), and the EVF 111 displays a live view. Also, the driving unit 103 stops, and the altazimuth mount 2 performs the astronomical object tracking operation.

At this point, if the user selects the astrophotography mode and gives an instruction to start photographing, the EVF 111 stops the live-view display and the image sensor 102 starts a still image exposure (an exposure for capturing a still image). The still image exposure may be performed once during the photographing period, but may also be performed multiple times, as exemplified in FIG. 10.

Also, the driving unit 103 moves the driving stage 131 to an initial position, and starts a field of view rotation correction before the still image exposure begins. The field of view rotation correction is an operation of rotating the driving stage 131 to correct the rotation of the photographic field of view (that is, to correct the image movement that occurs due to the angular velocity of earth of the camera 1 in the roll direction).

The altazimuth mount 2 continues to perform the astronomical object tracking operation similarly to before the instruction to start photographing.

Additionally, when photography ends, the image sensor 102, the driving unit 103, and the altazimuth mount 2 return to the state before the instruction to start photographing. Specifically, the image sensor 102 resumes the live-view exposure, the driving unit 103 stops, and the altazimuth mount 2 continues to perform the astronomical object tracking operation.

Note that, as exemplified in FIG. 10, in the case where the still image exposure is performed multiple times, multiple still images are obtained, and therefore the multiple still images may be combined later. In this case, the images may be combined according to a cumulative additive method or an additive-averaging method, for example. Note that when combining the images in this case, alignment (image rotation) is unnecessary.

As described above, according to the first embodiment, in the case of photographing with the camera 1 while tracking an astronomical object using the altazimuth mount 2 that is less expensive than an equatorial mount and also easy to set up, the rotation of the photographic field of view during exposure is corrected, thereby making it possible to achieve extend the exposure time and achieve photography that is substantially the same as an equatorial mount.

### Second Embodiment

Next, a second embodiment will be described. In the description of the second embodiment, the points that differ from the first embodiment will be described mainly. Also, structural elements that are the same as the first embodiment will be denoted with the same signs, and a description thereof will be omitted.

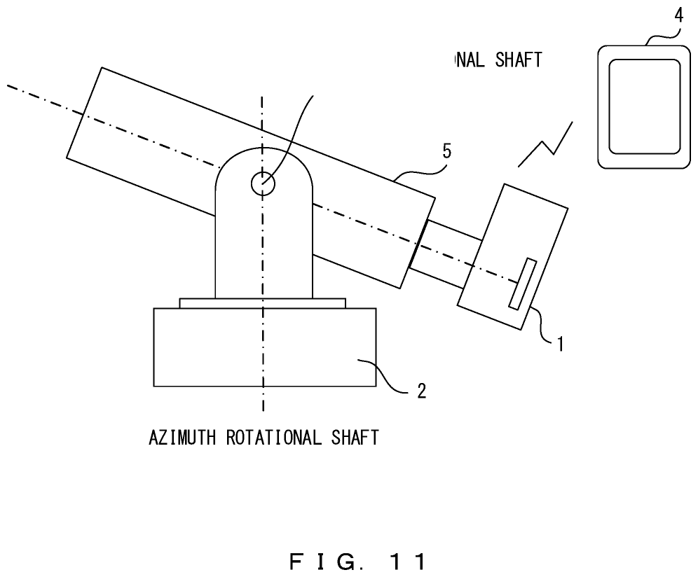

FIG. 11 is a diagram illustrating an example of a configuration of a photographic system according to a second embodiment.

The photographic system exemplified in FIG. 11 is provided with a camera 1, an altazimuth mount 2, an operating terminal (one example of an external device) 4, and a telescope 5.

The camera 1 and the telescope 5 are connected as a configuration for performing what is referred to as prime-focus photography. Specifically, a mount adapter (lens mount mechanism) is connected to the telescope 5 instead of an eyepiece lens, and the camera 1 is connected to the mount adapter.

The telescope 5 with camera 1 connected thereto is installed on the altazimuth mount 2. The altazimuth mount 2 is capable of changing the azimuth and elevation of the photographing direction of the camera 1 connected to the telescope 5 by the rotation about an azimuth rotational shaft and an elevation rotational shaft. Also, the altazimuth mount 2 switches the photographic target of the camera 1 and performs the astronomical object tracking operation for example, on the basis of instructions from the operating terminal 4.

The operating terminal 4 is a portable terminal such as a smartphone (registered trademark) or a tablet, and is also capable of functions such as remotely controlling both the altazimuth mount 2 and the camera 1. In the case of remotely controlling both the altazimuth mount 2 and the camera 1, the astronomical object tracking operation by the altazimuth mount 2 and the photographic operation by the camera 1 are controlled in a temporally synchronized way.

In the photographic system exemplified in FIG. 11, when the user specifies a target astronomical object with the operating terminal 4, the operating terminal 4 obtains the azimuth and elevation of the specified astronomical object at the current position and the current time, and controls the altazimuth mount 2 on the basis of the azimuth and elevation such that the specified astronomical object is contained in the field of view of the telescope 5. After that, the altazimuth mount 2 starts the astronomical object tracking operation. Additionally, when the user instructs the camera 1 to start photographing in the astrophotography mode through the operating terminal 4, the camera 1 takes images with the field of view rotation (the rotation of the photographic field of view) being corrected while the altazimuth mount 2 performs the astronomical object tracking operation.

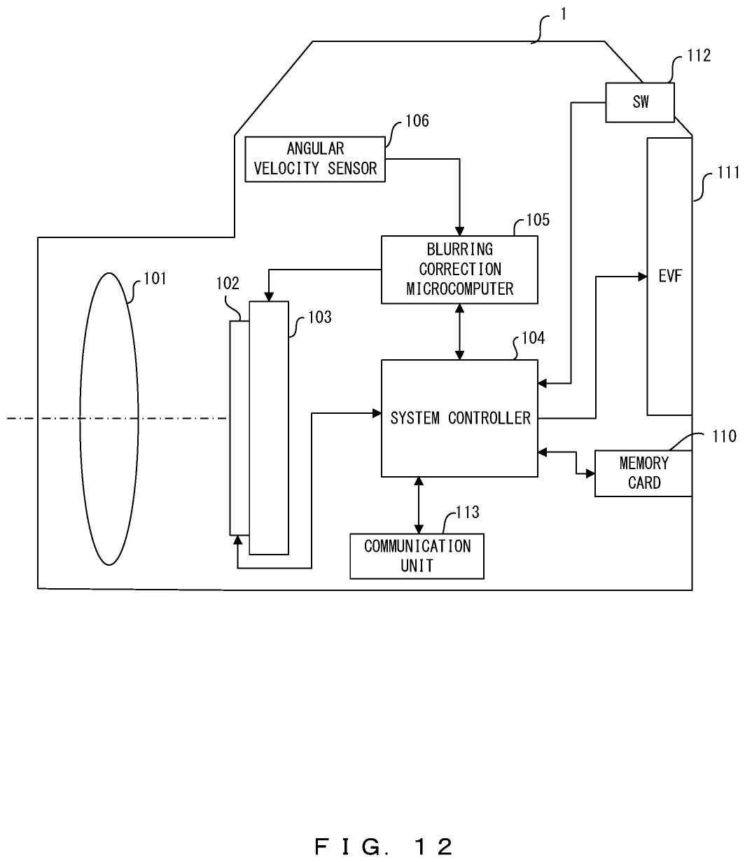

FIG. 12 is a diagram illustrating an example of a configuration of the camera 1 according to the second embodiment.

Compared to the camera 1 according to the first embodiment exemplified in FIG. 2, a communication unit 113 is newly added to the camera 1 according to the second embodiment exemplified in FIG. 12, while the acceleration sensor 107, the azimuth sensor 108, and the GPS sensor 109 are removed. This is because in the second embodiment, the major calculations for tracking an astronomical object and correcting the field of view rotation are performed by the operating terminal 4 rather than the camera 1.

The newly added communication unit 113 is a wireless communication interface such as Wi-Fi (registered trademark) that wirelessly communicates with the operating terminal 4 to acquire the angular velocity of earth and receive a photographing instruction from the operating terminal 4, for example.

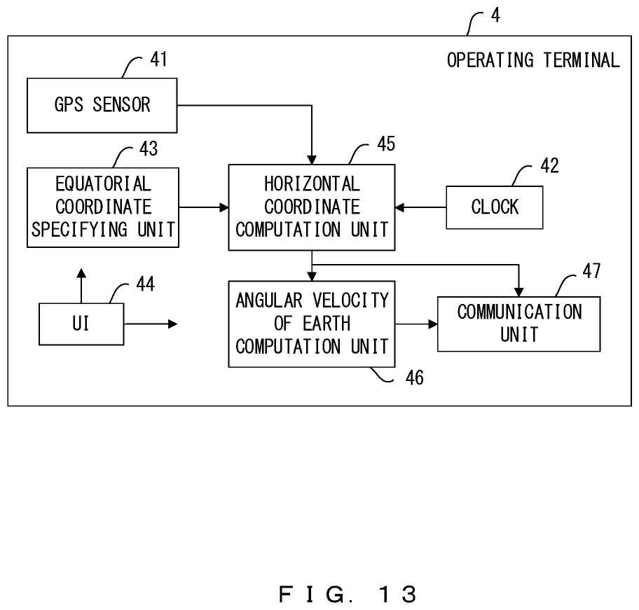

FIG. 13 is a diagram illustrating an example of the configuration of the operating terminal 4.

The operating terminal 4 exemplified in FIG. 13 is provided with a GPS sensor 41, a clock 42, an equatorial coordinate specifying unit 43, a user interface (UI) 44, a horizontal coordinate computation unit 45, an angular velocity of earth computation unit 46, and a communication unit 47. The GPS sensor 41, the clock 42, the equatorial coordinate specifying unit 43, and the horizontal coordinate computation unit 45 have substantially the same functions as the GPS sensor 31, the clock 32, the equatorial coordinate specifying unit 33, and the horizontal coordinate computation unit 35 exemplified in FIG. 7, and therefore a description is omitted here.

The UI 44 is a touch panel display for example, and is capable of displaying a menu, setting various settings in the operating terminal 4, issuing driving instructions to the altazimuth mount 2, issuing photographing instructions to the camera 1, and the like according to touch operations by the user.

The angular velocity of earth computation unit 46 computes the angular velocity of earth of the camera 1 in the yaw direction, the pitch direction, and the roll direction on the basis of the azimuth and elevation obtained by the horizontal coordinate computation unit 45 and the latitude of the current position detected by the GPS sensor 41. This computation may be performed using formulas (1) to (3) described above, for example.

The communication unit 47 is a wireless communication interface such as Wi-Fi, and wirelessly communicates with both the altazimuth mount 2 and the camera 1, for example. With this arrangement, the operating terminal 4 is capable of remotely controlling both the altazimuth mount 2 and the camera 1.

Note that the configuration of a portion of the operating terminal 4 (such as the equatorial coordinate specifying unit 43, the horizontal coordinate computation unit 45, and the angular velocity of earth computation unit 46) may be achieved by using hardware including a processor such as a CPU and memory, for example, in which the functions of the configuration are achieved by causing the processor to execute a program stored in the memory. Alternatively, for example, the configuration may be achieved using a dedicated circuit such as an ASIC or an FPGA.

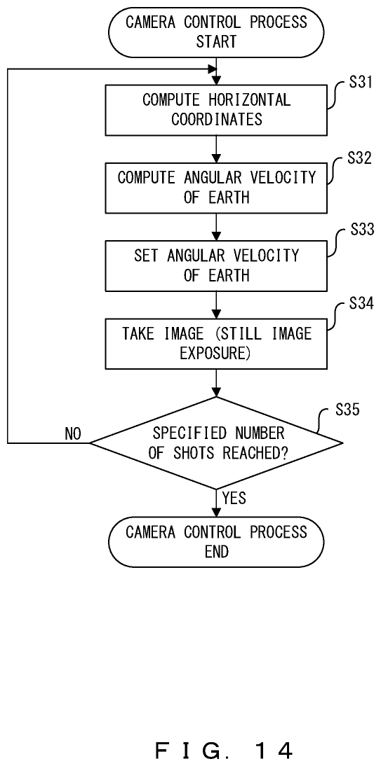

FIG. 14 is a flowchart illustrating an example of a flow of a camera control process performed by the operating terminal 4. The camera control process is started when the user selects the astrophotography mode in the camera 1 and instructs the camera 1 to start photographing (for example, gives an instruction to start composite photography) from the operating terminal 4. Also, when giving the instruction to start photographing, information such as the right ascension and declination as well as the total exposure time may be specified.

When the camera control process exemplified in FIG. 14 starts, first, the operating terminal 4 computes horizontal coordinates (azimuth and elevation) corresponding to the right ascension and declination based on a user specification (S31). Specifically, the horizontal coordinate computation unit 45 computes the azimuth and the elevation corresponding to the right ascension and the declination output by the equatorial coordinate specifying unit 43 according to the user specification, on the basis of the latitude and longitude of the current position detected by the GPS sensor 41 and the current date and time output by the clock 42.

Next, the operating terminal 4 computes the angular velocity of earth of the camera 1 in the yaw direction, the pitch direction, and the roll direction on the basis of the horizontal coordinates computed in S31 (S32). Specifically, the angular velocity of earth computation unit 46 computes the angular velocity of earth of the camera 1 in the yaw direction, the pitch direction, and the roll direction on the basis of the azimuth and elevation computed by the horizontal coordinate computation unit 45 and the latitude of the current position detected by the GPS sensor 41. This computation is performed using formulas (1) to (3) described above, for example.

Next, the operating terminal 4 sets 0 as the angular velocity of earth of the camera 1 in the yaw direction and the pitch direction in the camera 1, and sets the angular velocity of earth of the camera 1 in the roll direction computed in S32 in the camera 1 (S33). Specifically, the communication unit 47 notifies the camera 1 of the angular velocity of earth of the camera 1 in the yaw direction, the pitch direction, and the roll direction, and causes each angular velocity of earth to be stored in the corresponding angular velocity of earth storage unit 158 of the blurring correction microcomputer 105.

Also, in S33 of the first iteration of the process, the operating terminal 4 decides a still image exposure time for a single shot and the number of still images to take. This decision is made as follows, for example.

First, the following formula (4) is used to obtain a maximum value Tₑₓₚ of the still image exposure time for a single shot from the angular velocity of earth ωᵣₒₗₗ of the camera 1 in the roll direction computed in S32 and a rotatable limit (a maximum rotatable angle) θₗᵢₘᵢₜ of the driving stage 131 of the driving unit 103 in the camera 1.

Tₑₓₚ=θₗᵢₘᵢₜ/ωᵣₒₗₗ Formula (4)

For example, in the case where the photographic optical axis of the camera 1 is pointed at the North Star, the angular velocity of earth of the camera 1 in the roll direction is equal to Earth's rotation (approximately 0.004167° per second). At this time, in the case where the rotatable limit of the driving stage 131 of the driving unit 103 is 1°, the maximum value Tₑₓₚ of the still image exposure time for a single shot becomes approximately 240 seconds from Formula (4) above.

After obtaining the maximum value Tₑₓₚ of the still image exposure time for a single shot, the still image exposure time for a single shot is set to a value less than or equal to the maximum value Tₑₓₚ. Additionally, the number of still images to take is decided from the decided still image exposure time for a single shot and the total exposure time specified by the user.

After S33, the operating terminal 4 instructs the camera 1 to start photographing, and when the still image exposure time for a single shot decided in S33 elapses thereafter, the operating terminal 4 instructs the camera 1 to stop photographing (S34).

Next, the operating terminal 4 determines whether or not the number of images taken in S34 after starting the camera control process exemplified in FIG. 14 has reached the number of still images to take (whether or not the specified number of shots has been reached) that was decided in S33 (S35).

In the case where the determination result in S35 is NO, the process returns to S31.

On the other hand, in the case where the determination result in S35 is YES, the camera control process exemplified in FIG. 14 ends.

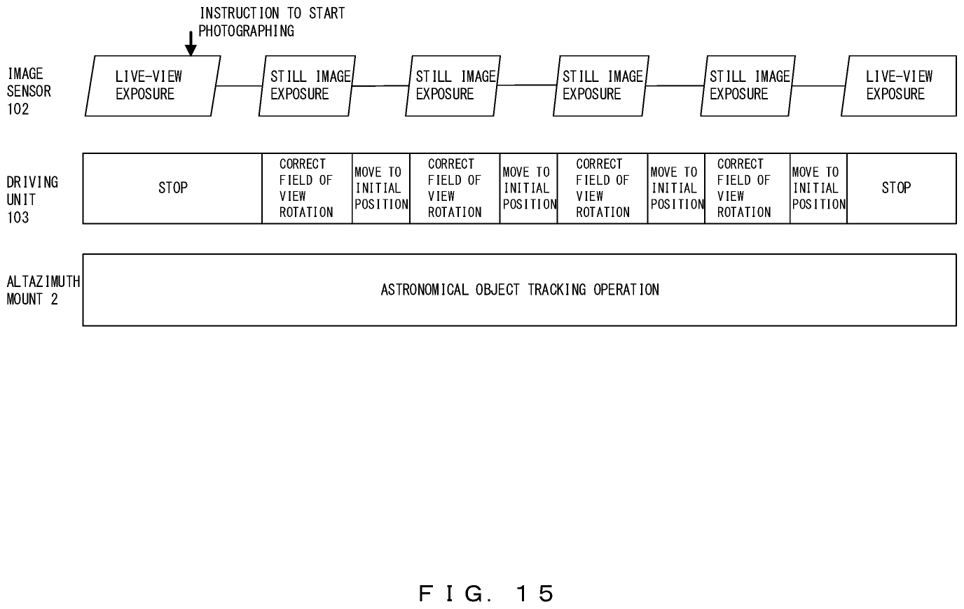

FIG. 15 is a timing chart illustrating an example of operations by the image sensor 102, the driving unit 103, and the altazimuth mount 2 arranged in a time series in the photographic system according to the second embodiment.

In the timing chart exemplified in FIG. 15, before the user gives an instruction to start photographing, the image sensor 102 performs a live-view exposure, and the EVF 111 displays a live view. Also, the driving unit 103 stops, and the driving stage 131 is in a stopped state at an initial position. In addition, the altazimuth mount 2 performs the astronomical object tracking operation.

Note that the astronomical object tracking operation by the altazimuth mount 2 is performed by having the operating terminal 4 execute a process similar to the altazimuth mount control process performed by the hand controller 3 according to the first embodiment (see FIG. 9), for example.

Additionally, when the user gives an instruction to start photographing, the EVF 111 stops the live-view display, and the image sensor 102 repeats the still image exposure for a single shot a number of times equal to the number of still images to take (in FIG. 15, four times).

Also, during the still image exposure, the driving unit 103 performs the field of view rotation correction, and when the still image exposure is not being performed (for example, during the period between a still image exposure and the next still image exposure), the driving unit 103 moves the driving stage 131 to the initial position.

The altazimuth mount 2 continues to perform the astronomical object tracking operation similarly to before the instruction to start photographing.

Additionally, when the decided number of still images have been taken, the image sensor 102, the driving unit 103, and the altazimuth mount 2 return to the state before the instruction to start photographing was given. Specifically, the image sensor 102 resumes the live-view exposure, the driving unit 103 stops, and the altazimuth mount 2 continues to perform the astronomical object tracking operation.

The plurality of still images obtained through such operations are subjected to image processing for composite photography in the camera 1, for example. Specifically, the second and subsequent still images are rotated by an amount corresponding to the field of view rotation that occurred between the time of starting the exposure of the first still image and the time of starting the exposure corresponding to each of the second and subsequent still images, and thereby aligned and combined with the first still image. With this arrangement, although the angle of view is narrowed, composite photography is possible.

As described above, in the second embodiment, a field of view rotation correction is performed to take images with the camera 1, while also performing the astronomical object tracking operation with the altazimuth mount 2. After a still image is taken, the driving stage 131 of the driving unit 103 is returned to the initial position before photographing the next still image. In this way, because the field of view rotation is corrected during the still image exposure, image blurring at the periphery of the angle of view is suppressed, and the image does not flow at the periphery of the angle of view.

Also, in the driving unit 103 of the camera 1, the driving stage 131 moves to the initial position during a period outside the exposure period. In other words, the driving stage 131 returns to the initial position before each still image exposure. For this reason, the number of still images to be taken is not limited by the rotatable range of the driving stage 131.

### Third Embodiment

Next, a third embodiment will be described. In the description of the third embodiment, the points that differ from the second embodiment will be described mainly. Also, structural elements that are the same as the second embodiment will be denoted with the same signs, and a description thereof will be omitted.

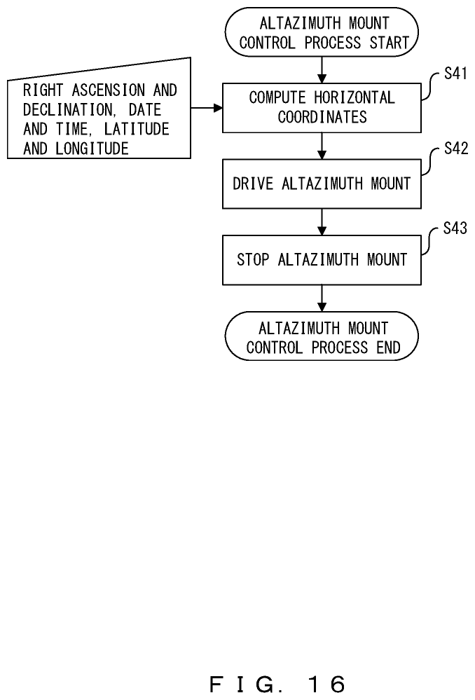

FIG. 16 is a flowchart illustrating an example of a flow of an altazimuth mount control process periodically performed by the operating terminal 4.

The altazimuth mount control process exemplified in FIG. 16 is a process causing the altazimuth mount 2 to perform the operation of automatically adopting an astronomical object. Specifically, first, the operating terminal 4 computes horizontal coordinates (azimuth and elevation) corresponding to the right ascension and declination based on a user specification (S41), similarly to S31 in FIG. 14.

Next, the operating terminal 4 drives the altazimuth mount 2 on the basis of the horizontal coordinates computed in S41 (S42), stops the altazimuth mount 2 when the driving is finished (S43), and ends the altazimuth mount control process exemplified in FIG. 16.

By periodically performing such an altazimuth mount control process exemplified in FIG. 16, the operation of automatically adopting an astronomical object is performed periodically in the altazimuth mount 2. In other words, the altazimuth mount 2 is driven intermittently (non-continuously).

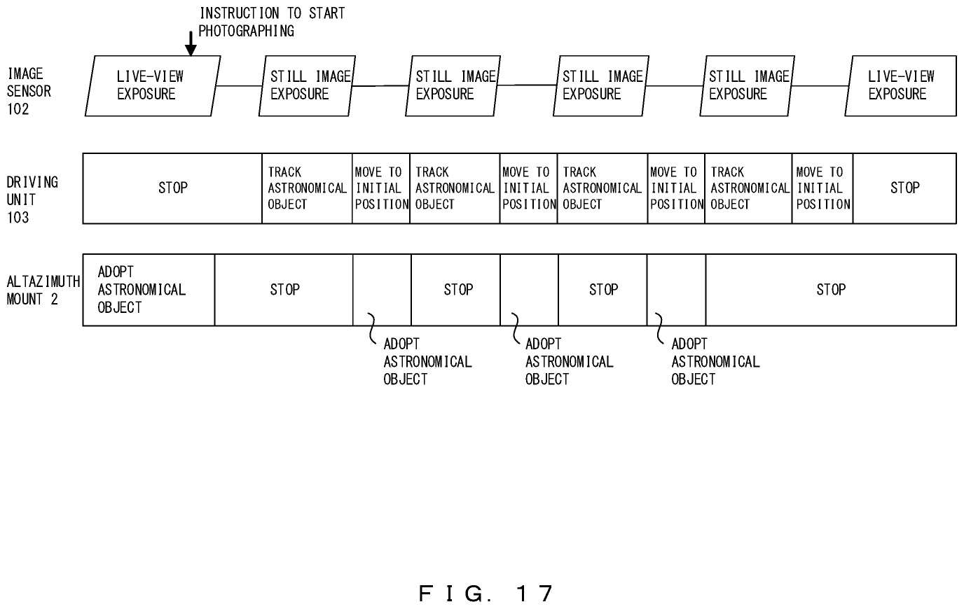

FIG. 17 is a timing chart illustrating an example of operations by the image sensor 102, the driving unit 103, and the altazimuth mount 2 arranged in a time series in the photographic system according to the third embodiment.

In the timing chart exemplified in FIG. 17, before the user gives an instruction to start photographing, the image sensor 102 performs a live-view exposure, and the EVF 111 displays a live view. Also, the driving unit 103 stops, and the driving stage 131 is in a stopped state at an initial position. Also, the altazimuth mount 2, under control by the operating terminal 4, repeatedly performs the astronomical object adoption operation (the operation of automatically adopting an astronomical object) and stops.

Additionally, when the user selects the astrophotography mode in the camera 1 and instructs the camera 1 to start photographing from the operating terminal 4, the EVF 111 stops the live-view display, and the image sensor 102, the driving unit 103, and the altazimuth mount 2 perform operations like the following under control by the operating terminal 4.

The image sensor 102 repeatedly performs the still image exposure for a single shot a number of times equal to the number of still images to take (in FIG. 17, four times).

During the still image exposure, the altazimuth mount 2 stops, and when the still image exposure is not being performed (for example, during the period between a still image exposure and the next still image exposure), the altazimuth mount 2 performs the astronomical object adoption operation.

During the still image exposure, the driving unit 103 performs the astronomical object tracking operation, and when the still image exposure is not being performed, the driving unit 103 performs the operation of moving the driving stage 131 to the initial position. Here, the astronomical object tracking operation by the driving unit 103 is performed on the basis of the angular velocity of earth of the camera 1 in the yaw direction, the pitch direction, and the roll direction computed by the operating terminal 4 on the basis of the horizontal coordinates at the time point when the astronomical object adoption operation by the altazimuth mount 2 is completed. In other words, in the third embodiment, not only image blurring correction based on the angular velocity of earth of the camera 1 in the roll direction (field of view rotation correction) but also image blurring correction based on the angular velocity of earth of the camera 1 in the yaw direction and the pitch direction are performed. With this arrangement, during the still image exposure, image blurring occurring due to diurnal motion can be corrected by the driving unit 103.

The plurality of still images obtained through such operations are subjected to image processing for composite photography in the camera 1, for example.

As described above, in the third embodiment, images are taken while alternately performing the astronomical object adoption operation by the altazimuth mount 2 and the astronomical object tracking operation by the camera 1. With this arrangement, even in the case where the altazimuth mount 2 has low astronomical object tracking precision, an astronomical object can be tracked precisely by the camera 1 during still image exposure. For this reason, the acquisition of an image degraded by image blurring or the like can be prevented.

Note that in the second and third embodiments described above, the processes for controlling the camera 1 and the altazimuth mount 2 performed by the operating terminal 4 (such as the control processes for achieving the operations of the camera 1 and the altazimuth mount 2 exemplified in FIG. 15 and FIG. 17, for example) may be achieved by a processor and memory provided in the operating terminal 4, in which the memory stores a program to be executed by the processor.

The embodiments described above are not limited to the configurations described in the first, second, and third embodiments described above, and various modifications and combinations are possible.

For example, in the first embodiment, the altazimuth mount control function of the hand controller 3 may also be provided in the camera 1, or in the altazimuth mount 2 itself. In this case, the hand controller 3 is unnecessary. As another example, in the second and third embodiments, the camera control function and the altazimuth mount control function of the operating terminal 4 may also be provided in the camera 1 or in the altazimuth mount 2. In this case, the operating terminal 4 is unnecessary.

As another example, instead of making the GPS sensor and the azimuth sensor unnecessary, the user may input the latitude and longitude detected by the GPS sensor and the azimuth detected by the azimuth sensor directly.

According to the above embodiment, by linking the altazimuth mount and a handheld camera shake correction mechanism, it is possible to achieve photography on a par with an equatorial mount with a configuration that is easy to set up and also relatively low-cost.

As another example, instead of the altazimuth mount 2, the camera 1 may be made to perform the astronomical object tracking operation by connecting the camera 1 to a stage device having two rotating shafts that rotate about a horizontal axis and a vertical axis. An electronic stabilizer and an electronic gimbal are examples of such a stage device. Additionally, in this case, instead of causing the image sensor 102 to rotate with respect to the camera 1, the camera 1 itself may be rotated by the stage device, for example. In this case, the camera 1 is one example of a target object, and the stage device is one example of a stabilizing device.

Such a stage device is described in the following supplementary notes.

### Supplement 1

A stage device comprising:
a platform to which an imaging device is connected;
a gimbal mechanism that rotates the platform;
a control circuit that controls the gimbal mechanism; and
an angular velocity sensor that detects a rotational angular velocity associated with an attitude change of the stage device,

wherein

the control circuit
in a case where a handheld camera shake correction mode is set, controls the gimbal mechanism on a basis of the rotational angular velocity detected by the angular velocity sensor to rotate the platform so as to correct a shaking of the imaging device connected to the platform, and
in a case where an astrophotography mode is set, controls the gimbal mechanism on a basis of angular velocity information for tracking an astronomical object to rotate the platform so as to correct at least a rotation of a subject image associated with diurnal motion of the imaging device connected to the platform.

### Supplement 2

The stage device according to Supplement 1, further comprising:
a current position information acquisition circuit that acquires current position information about the stage device;
an azimuth information acquisition circuit that acquires azimuth information about the platform; and
an attitude information acquisition circuit that acquires attitude information about the platform,

wherein

the angular velocity information for tracking an astronomical object is computed on a basis of the current position information, the azimuth information, the attitude information, and an angular velocity of earth.

### Supplement 3

The stage device according to Supplement 1, wherein

the angular velocity information for tracking an astronomical object is acquired from an external source.

What is claimed is:

1. A stabilizing device comprising:
a correction mechanism that moves a target object;
a control circuit that controls the correction mechanism; and
an angular velocity sensor that detects a rotational angular velocity associated with an attitude change of the stabilizing device,
wherein
the control circuit
when a first mode is set, controls the correction mechanism on a basis of the rotational angular velocity detected by the angular velocity sensor to rotate the target object and also move the target object in a horizontal direction and a vertical direction of the stabilizing device, and
when a second mode is set, controls the correction mechanism on a basis of a control angular velocity computed internally by the stabilizing device or a control angular velocity acquired from a source external to the stabilizing device, and at least rotates the target object.

2. The stabilizing device according to claim 1, further comprising:
a current position information acquisition circuit that acquires current position information about the stabilizing device;
an azimuth information acquisition circuit that acquires azimuth information about the stabilizing device; and
an attitude information acquisition circuit that acquires attitude information about the stabilizing device,
wherein
the control angular velocity is computed on a basis of the current position information, the azimuth information, the attitude information, and an angular velocity of earth.

3. An imaging device comprising:
an optical system;
an image sensor that converts a subject image formed by the optical system into an electrical signal;
a correction mechanism that moves the image sensor;
a control circuit that controls the correction mechanism; and
an angular velocity sensor that detects a rotational angular velocity associated with an attitude change of the imaging device,
wherein
the control circuit
when a first mode is set, controls the correction mechanism on a basis of the rotational angular velocity detected by the angular velocity sensor to rotate the image sensor about an optical axis of the optical system and also move the image sensor in a horizontal direction and a vertical direction of the imaging device, and
when a second mode is set, controls the correction mechanism on a basis of a control angular velocity computed internally by the imaging device or a control angular velocity acquired from a source external to the imaging device, and at least rotates the image sensor about the optical axis of the optical system.

4. The imaging device according to claim 3, further comprising:
a current position information acquisition circuit that acquires current position information about the imaging device;
an azimuth information acquisition circuit that acquires azimuth information about a photographing direction of the imaging device; and
an attitude information acquisition circuit that acquires attitude information about the imaging device,
wherein
the control angular velocity is computed on a basis of the current position information, the azimuth information, the attitude information, and an angular velocity of earth.

5. The imaging device according to claim 3, wherein
the imaging device is connected to a stage device that allows change in an azimuth and an elevation of a photographing direction of the imaging device, and
the stage device is driven such that the photographing direction of the imaging device tracks a target astronomical object.

6. The imaging device according to claim 4, wherein provided that
ωᵣₒₗₗ is the control angular velocity about the optical axis of the optical system,
ωᵣₒₜ is the angular velocity of earth,
θₗₐₜ is a latitude expressed by the current position information,
θ_{direction} is an azimuth expressed by the azimuth information, and
θₑₗₑ is an elevation expressed by the attitude information,
the control angular velocity ωᵣₒₗₗ is computed by
ωᵣₒₗₗ=ωᵣₒₜ×(cos θₗₐₜ×cos θ_{direction}×cos θₑₗₑ+sin θₗₐₜ×sin θₑₗₑ).

7. The imaging device according to claim 3, further comprising:
an image processor configured to control an exposure of the image sensor, control a readout of video image data, control image processing performed on the video image data, and control a recording of processed video image data to a recording medium,
wherein
the image processor
acquires a single still image by causing the image sensor to perform a single still image exposure, or acquires a plurality of still images by causing the image sensor to perform the still image exposure a plurality of times, and combines the plurality of still images according to a cumulative additive method or an additive-averaging method.

8. The imaging device according to claim 7, wherein
the control circuit
rotates the image sensor about the optical axis of the optical system on a basis of the control angular velocity during the still image exposure.

9. The imaging device according to claim 3, wherein
in a case where the imaging device takes a plurality of shots in succession,
the control circuit
during a period of exposing a still image on the image sensor, controls the correction mechanism on a basis of the control angular velocity to rotate the image sensor about the optical axis of the optical system, and
during a period of not exposing a still image on the image sensor, initializes the correction mechanism to move the image sensor to an initial position.

10. The imaging device according to claim 9, wherein
in the case of taking a plurality of shots in succession, a still image exposure time for a single shot and the number of shots are decided on a basis of a maximum angle by which the image sensor is rotatable about the optical axis of the optical system by the correction mechanism, the control angular velocity for rotating the image sensor about the optical axis of the optical system, and a total exposure time of the plurality of shots taken in succession.

11. The imaging device according to claim 3, wherein
in a case where the imaging device takes a plurality of shots in succession,
the control circuit
during a period of exposing a still image on the image sensor, controls the correction mechanism on a basis of the control angular velocity to rotate the image sensor about the optical axis of the optical system and also move the image sensor in the horizontal direction and the vertical direction of the imaging device, and
during a period of not exposing a still image on the image sensor, initializes the correction mechanism to move the image sensor to an initial position.

12. The imaging device according to claim 11, wherein
the imaging device is connected to a stage device that allows change in an azimuth and an elevation of a photographing direction of the imaging device, and
in the case of taking a plurality of shots in succession, during a period of exposing a still image, the stage device is stopped, and during a period of not exposing a still image, the stage device is driven such that a photographing direction of the imaging device tracks a target astronomical object.

13. The imaging device according to claim 11, wherein provided that
ω_{pitch} is the control angular velocity about a horizontal axis of the imaging device,
ω_{yaw} is the control angular velocity about a vertical axis of the imaging device,
ωᵣₒₗₗ is the control angular velocity about the optical axis of the optical system,
ωᵣₒₜ is the angular velocity of earth,
ωₗₐₜ is a latitude of a current position of the imaging device,
θ_{direction} is an azimuth of the photographing direction of the imaging device, and
θₑₗₑ is an elevation of the photographing direction of the imaging device,
the control angular velocities ω_{pitch}, ω_{yaw}, and ωᵣₒₗₗ are computed by
ω_{pitch}=ωᵣₒₜ×(cos θₗₐₜ×sin θ_{direction}),
ω_{yaw}=ωᵣₒₜ×(sin θₗₐₜ×cos θₑₗₑ−cos θₗₐₜ×cos θ_{direction}×sin θₑₗₑ), and
ωᵣₒₗₗ=ωᵣₒₜ×(cos θₗₐₜ×cos θ_{direction×}cos θₑₗₑ+sin θₗₐₜ×sin θₑₗₑ).

14. The imaging device according to claim 3, further comprising:
a communication interface that communicates with an external device, wherein
the control angular velocity is acquired from the external device through the communication interface.

15. A photographic system comprising:
an imaging device; and
a stage device to which the imaging device is connected,
wherein
the imaging device includes
an optical system,
an image sensor that converts a subject image formed by the optical system into an electrical signal,
a correction mechanism that moves the image sensor,
a control circuit that controls the correction mechanism, and
an angular velocity sensor that detects a rotational angular velocity associated with an attitude change of the imaging device,
the control circuit
when a first mode is set, controls the correction mechanism on a basis of the rotational angular velocity detected by the angular velocity sensor to rotate the image sensor about an optical axis of the optical system and also move the image sensor in a horizontal direction and a vertical direction of the imaging device, and
when a second mode is set, controls the correction mechanism on a basis of a control angular velocity computed internally by the imaging device or a control angular velocity acquired from a source external to the imaging device, and at least rotates the image sensor about the optical axis of the optical system,
the stage device includes
a first rotating shaft that changes an azimuth of a photographing direction of the imaging device,
a second rotating shaft that changes an elevation of the photographing direction of the imaging device, and
a driving device that rotates the first rotating shaft and the second rotating shaft, and
the driving device rotates the first rotating shaft and the second rotating shaft such that the photographing direction of the imaging device tracks a target astronomical object.

16. A stabilizing method by a stabilizing device provided with a correction mechanism that moves a target object and an angular velocity sensor that detects a rotational angular velocity associated with an attitude change, comprising:
controlling, when a first mode is set, the correction mechanism on a basis of the rotational angular velocity detected by the angular velocity sensor to rotate the target object and also move the target object in a horizontal direction and a vertical direction of the stabilizing device, and
controlling, when a second mode is set, the correction mechanism on a basis of a control angular velocity computed internally by the stabilizing device or a control angular velocity acquired from a source external to the stabilizing device, and at least rotating the target object.

17. A photographic method of an imaging device provided with an optical system, an image sensor that converts a subject image formed by the optical system into an electrical signal, a correction mechanism that moves the image sensor, and an angular velocity sensor that detects a rotational angular velocity associated with an attitude change, comprising:
controlling, when a first mode is set, the correction mechanism on a basis of the rotational angular velocity detected by the angular velocity sensor to rotate the image sensor about an optical axis of the optical system and also move the image sensor in a horizontal direction and a vertical direction of the imaging device, and
controlling, when a second mode is set, the correction mechanism on a basis of a control angular velocity computed internally by the imaging device or a control angular velocity acquired from a source external to the imaging device, and at least rotating the image sensor about the optical axis of the optical system.

18. The photographic method according to claim 17, wherein
the imaging device is connected to a stage device that allows change in an azimuth and an elevation of a photographing direction of the imaging device,
the photographic method further comprising:
driving the stage device such that a photographing direction of the imaging device tracks a target astronomical object.

19. A non-transitory recording medium storing a program causing a processor to execute a photographic control process,
the photographic control process comprising an imaging device control process, wherein
the imaging device control process causes
an imaging device provided with an optical system, an image sensor that converts a subject image formed by the optical system into an electrical signal, a correction mechanism that moves the image sensor, and an angular velocity sensor that detects a rotational angular velocity associated with an attitude change
to execute a process including
when a first mode is set, controlling the correction mechanism on a basis of the rotational angular velocity detected by the angular velocity sensor to rotate the image sensor about an optical axis of the optical system and also move the image sensor in a horizontal direction and a vertical direction of the imaging device, and
when a second mode is set, controlling the correction mechanism on a basis of a control angular velocity computed internally by the imaging device or a control angular velocity acquired from a source external to the imaging device, and at least rotating the image sensor about the optical axis of the optical system.

20. The recording medium according to claim 19,
the photographic control process further comprising a stage device control process, wherein
when the imaging device is connected to a stage device that allows change in an azimuth and an elevation of a photographing direction of the imaging device,
the stage device control process causes the stage device to execute a process including
driving the stage device such that the photographing direction of the imaging device tracks a target astronomical object.
